(19) United States
(12) Patent Application Publication
(10) Pub. No.: US 2014/0075928 A1
(43) Pub. Date: Mar. 20, 2014

(54) HYDRAULIC CONTROL MANIFOLD ASSEMBLY

(71) Applicant: Caterpillar Global Mining LLC, Oak Creek, WI (US)

(72) Inventors: John Luvaas, Mequon, WI (US); Michael Wheeler, South Point, OH (US)

(21) Appl. No.: 13/621,795

(22) Filed: Sep. 17, 2012

(51) Int. Cl. F15B 15/02

(52) U.S. Cl. CPC F15B 15/02
USPC 60/327; 60/459

(57) ABSTRACT

A hydraulic manifold assembly for hydraulic equipment is provided. The hydraulic manifold assembly includes a hydraulic manifold. The hydraulic manifold includes at least four control valves substantially disposed within the hydraulic manifold, at least three check valves substantially disposed within the hydraulic manifold, at least one control module, at least one control valve fluid line, and at least one check valve line. The hydraulic manifold assembly also includes at least one hydraulic cylinder, a hydraulic tank, and at least one hydraulic pump fluidly connected to the hydraulic manifold, and also fluidly connected to the hydraulic tank.

### TECHNICAL FIELD

This disclosure relates generally to the field of hydraulic pressure systems, and more particularly to a hydraulic manifold assembly for use in hydraulic pressure systems in large hydraulic equipment.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Hydraulic manifolds may be used within hydraulic pressure systems to regulate fluid flow between pumps and actuators, and other system components. Typically, manifolds used on hydraulic shovels utilize external fluid lines to fluidly connect control valves and other components manifold components. However, external fluid lines are susceptible to leak points, as well as to other damage from outside the system. Leak points in the hydraulic system lead to reduced efficiency of the equipment, equipment downtime due to maintenance and repair, and further equipment downtime for cleaning the fluid that leaks onto the equipment.

Conventional manifolds may also use pilot hydraulic pumps to pump hydraulic fluid to the control valves in order to move the valves between an open and a closed position. The pilot pumps are powered by motors or off of a gearbox driven by an engine, which may increase energy costs associated with the equipment. The pilot pumps also include filters and other associated parts, which must be repaired and replaced, leading to further maintenance costs.

### SUMMARY

An embodiment of the present disclosure relates to a hydraulic manifold assembly for hydraulic equipment. The hydraulic manifold assembly includes a hydraulic manifold, including at least four control valves configured to move between an open position and a closed position, the control valves substantially disposed within the hydraulic manifold, and each control valve being configured to fluidly connect to each other control valve. The hydraulic manifold also includes at least three check valves substantially disposed within the hydraulic manifold, each check valve being fluidly connected to each other check valve. The hydraulic manifold also includes at least one control module fluidly connected to at least one control valve, and configured to toggle between a first state and a second state, and at least one control valve fluid line substantially disposed within the hydraulic manifold, and configured to fluidly connect the control valves. The hydraulic manifold further includes at least one check valve line substantially disposed within the hydraulic manifold, and configured to fluidly connect the check valves.

In this embodiment, the hydraulic manifold assembly includes at least one hydraulic cylinder fluidly connected to at least one control valve and having at least two ends, including a rod cylinder end and a head cylinder end, the hydraulic cylinder configured to move a hydraulic attachment between a first position and a second position. The hydraulic manifold assembly also includes a hydraulic tank fluidly connected to the hydraulic manifold. The hydraulic manifold assembly further includes at least one hydraulic pump fluidly connected to the hydraulic manifold, and also fluidly connected to the hydraulic tank.

Another embodiment of the present disclosure relates to a hydraulic manifold for hydraulic pressure systems. The hydraulic manifold includes at least four control valves configured to move between an open position and a closed position, the control valves substantially disposed within the hydraulic manifold, each control valve being configured to fluidly connect to each other control valve. The hydraulic manifold also includes at least three check valves substantially disposed within the hydraulic manifold, each check valve being fluidly connected to each other check valve, and at least one control module fluidly connected to at least one control valve, and configured to toggle between a first state and a second state. The hydraulic manifold further includes at least one control valve fluid line substantially disposed within the hydraulic manifold, and configured to fluidly connect the control valves, and at least one check valve line substantially disposed within the hydraulic manifold, and configured to fluidly connect the check valves.

Another embodiment of the present disclosure relates to a method for providing a hydraulic manifold assembly for hydraulic equipment. The method includes providing a hydraulic manifold. The hydraulic manifold includes at least four control valves configured to move between an open position and a closed position, the control valves substantially disposed within the hydraulic manifold, each control valve being configured to fluidly connect to each other control valve. The hydraulic manifold also includes at least three check valves substantially disposed within the hydraulic manifold, each check valve being fluidly connected to each other check valve, and at least one control module fluidly connected to at least one control valve, and configured to toggle between a first state and a second state. The hydraulic manifold further includes at least one control valve fluid line substantially disposed within the hydraulic manifold, and configured to fluidly connect the control valves, and at least one check valve line substantially disposed within the hydraulic manifold, and configured to fluidly connect the check valves.

In this embodiment, the method also includes providing at least one hydraulic cylinder fluidly connected to at least one control valve and having at least two ends, including a rod cylinder end and a head cylinder end, the hydraulic cylinder configured to move a hydraulic attachment between a first position and a second position. The method also includes providing a hydraulic tank fluidly connected to the hydraulic manifold. The method further includes providing at least one hydraulic pump fluidly connected to the hydraulic manifold, and also fluidly connected to the hydraulic tank.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a view of a hydraulic mining shovel, according to an exemplary embodiment.

FIG. 2 is a schematic for the hydraulic manifold assembly of the present disclosure, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

The hydraulic manifold assembly of the present disclosure represents a portion of a hydraulic pressure system, forming a hydraulic circuit. The hydraulic manifold assembly includes a hydraulic manifold, which may be used to regulate fluid flow between pumps and actuators within hydraulic a hydraulic pressure system, and may be used to move hydraulic components within the system. In exemplary embodiments, the hydraulic manifold assembly of the present disclosure includes a hydraulic manifold utilizing fluid lines disposed substantially within the manifold, which is intended to reduce fluid leaks within the assembly. The hydraulic manifold assembly of the present disclosure may also be configured to select the highest pressure hydraulic fluid within the system, and may be configured further to use the highest pressure fluid to move components within the system.

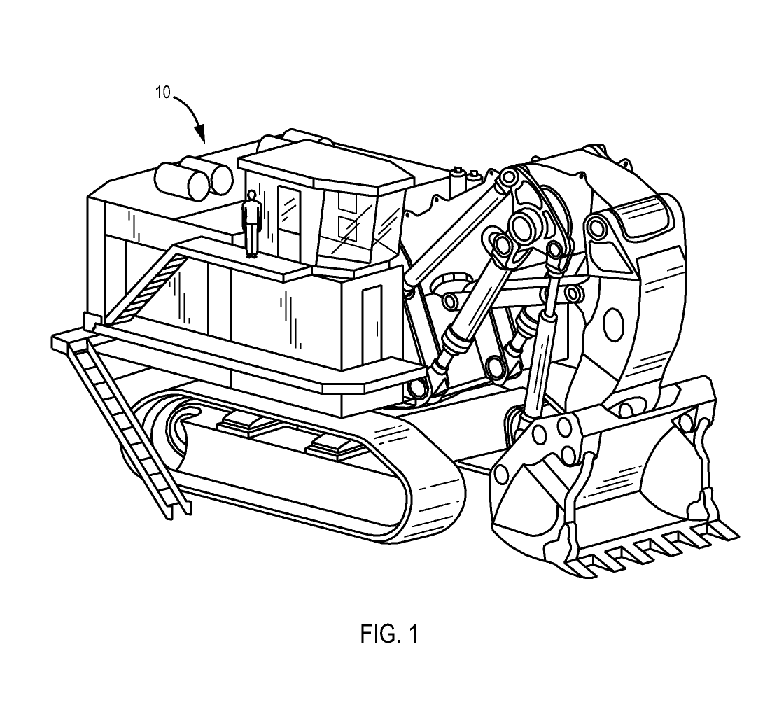

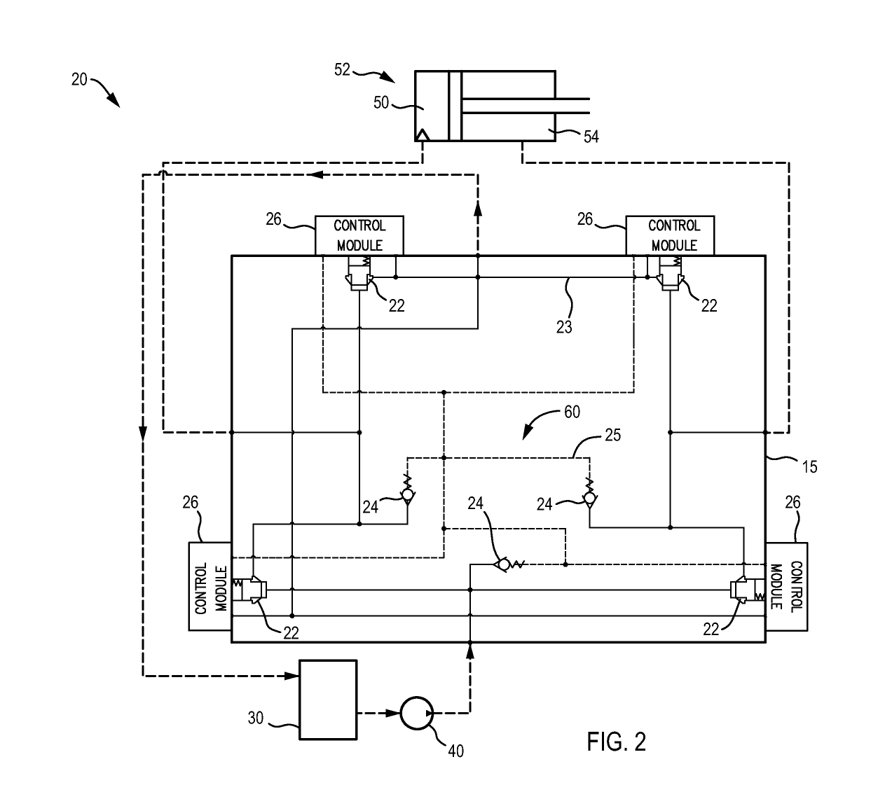

Referring to FIG. 1, a hydraulic mining shovel is shown. The hydraulic manifold assembly 20 (shown in FIG. 2) of the present disclosure is intended to be used in large hydraulic mining equipment, such as the hydraulic mining shovel 10 shown in FIG. 1. The hydraulic manifold assembly 20 may be used at least to control working implements within the hydraulic shovel 10.

Referring now to FIG. 2, a schematic for the hydraulic manifold assembly of the present disclosure is shown. The hydraulic manifold assembly 20 includes a hydraulic manifold 15, the boundary of which is represented in FIG. 2 by a dark, solid line. The hydraulic manifold 15 may be used to regulate fluid flow between the hydraulic components of the assembly 20, in exemplary embodiments.

The hydraulic manifold assembly 20 also includes at least one control module 26, each control module 26 having a first state and a second state. The control modules 26 may be configured to receive energy in the first state, and to not receive energy in the second state. In the illustrated embodiment of FIG. 2, the hydraulic manifold assembly 20 includes four control modules 26, but the assembly 20 may include any number of modules 26 as is suitable for the particular application. The control modules 26 are disposed on the outside of the hydraulic manifold 15, in this embodiment, but may be disposed in any other location suitable for the application. In exemplary embodiments, the control modules 26 are fluidly connected to at least one component within the hydraulic manifold assembly 20.

In the illustrated embodiment of FIG. 2, the four control modules 26 are fluidly connected to four control valves 22. The hydraulic manifold assembly 20 includes four control valves 22 in this embodiment, but may include whatever amount is suitable for the particular application. In exemplary embodiments, the control valves 22 are disposed substantially within the hydraulic manifold 15. The control valves 22 are fluidly connected to four control modules 26, which are configured to allow the control valves 22 to open or close.

In exemplary embodiments, the control valves 22 are moveable between an open position and a closed position (positions not shown). In these exemplary embodiments, the control valves 22 may open or close based on the state of the control modules 26. When the control modules 26 are in the first state, the control valves 22 may be allowed to move to the open position, and when the control modules 26 are in the second state, the control valves 22 may not be allowed to move to the open position, or may be moved to the closed position. In the open position, the control valves 22 are intended to route fluid to preferred destinations within the assembly 20, and in the closed position the valves 22 are intended to substantially block hydraulic fluid flow. In other embodiments, pilot valves (not shown) are included within the assembly 20 in place of the control modules 26, and are configured to allow the control valves 22 to move between an open and closed position.

The hydraulic manifold assembly 20 also includes a hydraulic pump 40, which is fluidly connected to the control valves 22. The hydraulic pump 40 receives hydraulic fluid from a hydraulic tank 30, and is configured to pump the fluid into the hydraulic manifold 15 by control fluid lines 23. In exemplary embodiments, the fluid lines 23 are disposed substantially within the hydraulic manifold 15. The fluid lines 23 fluidly connect the pump 40 to the control valves 22. In exemplary embodiments, the control valves 22 are also fluidly connected to at least one hydraulic cylinder 50. In these embodiments, the control modules 26 are configured to toggle between a first state and a second state, “unlocking” the selected control valves 22, or allowing them to move to the open position when in the first state, and not unlocking the selected control valves 22, or not allowing them to move to the open position when in the second state. Once the selected control valves 22 are “unlocked,” the pressurized hydraulic fluid from the hydraulic pump 40 flows through the control fluid lines 23 to the control valves 22, forcing the control valves 22 to move into the open position.

Once the selected control valves 22 are in the open position, pressurized fluid is allowed to flow through the selected control valves 22. In exemplary embodiments, the control valve 22 leading from the pump 40 to the head end of the cylinder 52 may be forced into the open position by fluid pressure, and the control valve 22 leading from the rod end of the cylinder 54 to the tank 30 may also be forced into the open position by fluid pressure. In these embodiments, the pressurized fluid then flows through the control valve 22 and into the head end of the cylinder 52, and fluid also flows from the rod end of the cylinder 54 to the tank 30, building fluid pressure within the cylinder 50. The pressurized cylinder 50 may be connected to a hydraulic attachment, such as the boom (not shown). In these exemplary embodiments, the pressurized fluid in the cylinder 50 is intended to cause the boom (not shown) to raise up. However, in other embodiments, the cylinder 50 may be used to operate the stick (not shown), or any other hydraulic attachment.

The hydraulic manifold assembly 20 further includes at least one check valve 24. In the illustrated embodiment of FIG. 2, the assembly 20 includes three check valves 24, but the assembly 20 may include any number of check valves 24 as may be suitable for the particular application. In this embodiment, the check valves 24 are substantially disposed within the hydraulic manifold 15. The check valves 24 are one-way valves with two ends, a first end configured to receive hydraulic fluid, and a second end configured to send hydraulic fluid out of the valve 24. The check valves 24 are connected by check valve fluid lines 25, which are also substantially disposed within the hydraulic manifold 15, in exemplary embodiments. The location of the check valves 24 and the check valve fluid lines 25 within the manifold 15 is intended to reduce or prevent fluid leaks within the assembly 20.

In the illustrated embodiment of FIG. 2, the check valves 24 are configured to receive the highest pressure hydraulic fluid that is available within the hydraulic manifold assembly 20. In this embodiment, the check valves 24 are fluidly connected to the hydraulic pump 40, the head end of the cylinder 52, or the rod end of the cylinder 54, and may receive fluid from any of the components 40, 52, or 54 within the assembly 20. The check valves 24 are configured to receive fluid from the component 40, 52, or 54 with the highest fluid pressure. The check valves 24 “check in” the highest pressure fluid, receiving fluid through the check valves 24 and into the fluid circuit 60 formed by the check valve fluid lines 25. As fluid pumps into the fluid circuit 60, the circuit 60 is charged with the highest pressure hydraulic fluid available within the assembly 20.

The pressurized fluid within the check valve fluid circuit 60 is used to close the control valves 22 in exemplary embodiments. In order to close an open control valve 22, the connected control module 26 is toggled or switched to the second state, no longer allowing the control valve 22 to move to the open position. In exemplary embodiments, when the control module 26 is toggled or switched to the second state, pressurized fluid is directed from the fluid circuit 60 to close the control valve 22. The pressurized fluid closes the valve 22 by applying pressure greater than that of the pump 40, in the opposite direction of the fluid from the pump 40. In other embodiments, the control valves 22 are moved between the open and closed positions by a separate pilot pump (not shown). The pilot pump (not shown) in these embodiments is dedicated to supplying hydraulic fluid to shift the control valves 22.

The valve 22 can be closed more quickly by turning off the hydraulic pump 40, so that the pressurized fluid no longer forces the control valve 22 open. However, the fluid circuit 60 can also be used to close a control valve 22 when the hydraulic pump 40 is turned on, in exemplary embodiments. The fluid circuit 60 pulls and stores the highest pressure hydraulic fluid from the hydraulic manifold assembly 20, so the pressurized fluid from the fluid circuit 60 may be used to close the control valve 22 even in opposition to the force of the hydraulic pump 40. The control valves 22 may be moved back to the closed position by the pressurized fluid from the fluid circuit 60, in exemplary embodiments.

In exemplary embodiments, the control valve 22 leading from the pump 40 to the head end of the cylinder 52 may be forced into the open position by fluid pressure, and the control valve 22 leading from the rod end of the cylinder 54 to the tank 30 may also be forced into the open position by fluid pressure. By opening these valves 22, pressurized fluid may be built up within the cylinder 50, which may be connected to a hydraulic attachment such as a boom (not shown). Pressurizing the cylinder 50 may cause the boom (not shown) to raise in these embodiments. If the control valves 22 are moved to the closed position in these embodiments, the boom (not shown) will be lowered back to its original position. In other embodiments, the cylinder 50 may be used to operate the stick (not shown), or any other hydraulic attachment.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It should be noted that the orientation of various elements may differ according to other exemplary embodiments, and that such variations are intended to be encompassed by the present disclosure.

It is also important to note that the construction and arrangement of the systems and methods for providing the hydraulic manifold assembly as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed herein. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the various exemplary embodiments without departing from the scope of the present inventions.

### INDUSTRIAL APPLICABILITY

The disclosed hydraulic control manifold assembly may be utilized in any hydraulic equipment, including but not limited to mining equipment such as hydraulic mining shovels. The disclosed hydraulic control manifold assembly is intended to reduce fluid leaks within a hydraulic manifold, and to maintain the highest possible hydraulic fluid pressure within the manifold.

Current hydraulic manifold assemblies have external pilot lines running to the control valves. These external fluid lines introduce more leak points and more failure points within the assembly. The hydraulic control manifold assembly of the present disclosure has fluid lines and control valves disposed completely within the hydraulic manifold, which may reduce or prevent hydraulic fluid leaks, and may reduce the amount of failure points within the hydraulic manifold assembly.

Current hydraulic manifold assemblies may also utilize pilot pumps in order to open or close control valves within the hydraulic manifold assembly. These pilot pumps are typically powered by a motor, consuming energy, and include filters and other components that must be replaced or repaired. The hydraulic control manifold assembly of the present disclosure does not include a pilot pump, in exemplary embodiments. Instead, the hydraulic control manifold assembly of the present disclosure includes check valves configured to pull the highest pressure hydraulic fluid from within the hydraulic control manifold assembly. The check valves pull the pressurized fluid into a fluid circuit, and the fluid is used to close the control valves within the assembly.

It will be apparent to those skilled in the art that various modifications and variations can be made to the disclosed hydraulic control manifold assembly. Other embodiments will be apparent to those skilled in the art from consideration of the specification and practice of the disclosed hydraulic control manifold assembly. It is intended that the specification and examples be considered as exemplary only, with a true scope being indicated by the following claims and their equivalents.

What is claimed is:

1. A hydraulic manifold assembly for hydraulic equipment, comprising:
a hydraulic manifold, comprising:
at least four control valves configured to move between an open position and a closed position, the control valves substantially disposed within the hydraulic manifold, each control valve being configured to fluidly connect to each other control valve;
at least three check valves substantially disposed within the hydraulic manifold, each check valve being fluidly connected to each other check valve;
at least one control module fluidly connected to at least one control valve, and configured to toggle between a first state and a second state;
at least one control valve fluid line substantially disposed within the hydraulic manifold, and configured to fluidly connect the control valves;
at least one check valve line substantially disposed within the hydraulic manifold, and configured to fluidly connect the check valves;
at least one hydraulic cylinder fluidly connected to at least one control valve and having at least two ends, including a rod cylinder end and a head cylinder end, the hydraulic cylinder configured to move a hydraulic attachment between a first position and a second position;
a hydraulic tank fluidly connected to the hydraulic manifold; and
at least one hydraulic pump fluidly connected to the hydraulic manifold, and also fluidly connected to the hydraulic tank.

2. The hydraulic manifold assembly of claim 1, wherein the hydraulic manifold includes at least two check valve lines, the check valve lines fluidly connected to each other and forming a fluid circuit.

3. The hydraulic manifold assembly of claim 2, wherein the check valves are configured to receive the highest pressure hydraulic fluid from within the hydraulic manifold assembly and to store the pressurized hydraulic fluid within the fluid circuit.

4. The hydraulic manifold assembly of claim 1, wherein the hydraulic manifold assembly is configured to control the movement of at least one hydraulic attachment.

5. The hydraulic manifold assembly of claim 1, wherein the hydraulic manifold includes four control modules, each control module being connected to at least one control valve.

6. The hydraulic manifold assembly of claim 1, wherein at least one control valve is configured to supply hydraulic fluid to at least one hydraulic cylinder.

7. The hydraulic manifold assembly of claim 1, further comprising a pilot pump fluidly connected to the control valves, the pilot pump configured to move the control valves to a closed position.

8. The hydraulic manifold assembly of claim 1, wherein the control valves are fluidly connected to the hydraulic pump.

9. The hydraulic manifold assembly of claim 1, wherein the control module is configured to allow the control valve to move to the open position when the control module is in the first state, and configured to not allow the control valve to move to the open position when the control module is in the second state.

10. A hydraulic manifold for hydraulic pressure systems, comprising:
at least four control valves configured to move between an open position and a closed position, the control valves substantially disposed within the hydraulic manifold, each control valve being configured to fluidly connect to each other control valve;
at least three check valves substantially disposed within the hydraulic manifold, each check valve being fluidly connected to each other check valve;
at least one control module fluidly connected to at least one control valve, and configured to toggle between a first state and a second state;
at least one control valve fluid line substantially disposed within the hydraulic manifold, and configured to fluidly connect the control valves;
at least one check valve line substantially disposed within the hydraulic manifold, and configured to fluidly connect the check valves;

11. The hydraulic manifold of claim 10, wherein the hydraulic manifold includes at least two check valve lines, the check valve lines fluidly connected to each other and forming a fluid circuit.

12. The hydraulic manifold of claim 11, wherein the check valves are configured to receive the highest pressure hydraulic fluid from within a hydraulic manifold assembly and store the pressurized hydraulic fluid within the fluid circuit.

13. The hydraulic manifold of claim 10, wherein the hydraulic manifold includes four control modules, each control module being connected to at least one control valve.

14. The hydraulic manifold of claim 10, wherein the control module is configured to allow the control valve to move to the open position when the control module is in the first state, and configured to not allow the control valve to move to the open position when the control module is in the second state.

15. A method for providing a hydraulic manifold assembly for hydraulic equipment, the method comprising:
providing a hydraulic manifold, comprising:
at least four control valves configured to move between an open position and a closed position, the control valves substantially disposed within the hydraulic manifold, each control valve being configured to fluidly connect to each other control valve;
at least three check valves substantially disposed within the hydraulic manifold, each check valve being fluidly connected to each other check valve;
at least one control module fluidly connected to at least one control valve, and configured to toggle between a first state and a second state;
at least one control valve fluid line substantially disposed within the hydraulic manifold, and configured to fluidly connect the control valves;
at least one check valve line substantially disposed within the hydraulic manifold, and configured to fluidly connect the check valves;
providing at least one hydraulic cylinder fluidly connected to at least one control valve and having at least two ends, including a rod cylinder end and a head cylinder end, the hydraulic cylinder configured to move a hydraulic attachment between a first position and a second position;
providing a hydraulic tank fluidly connected to the hydraulic manifold; and
providing at least one hydraulic pump fluidly connected to the hydraulic manifold, and also fluidly connected to the hydraulic tank.

16. The method of claim 15, wherein the hydraulic manifold includes at least two check valve lines, the check valve lines fluidly connected to each other and forming a fluid circuit.

17. The method of claim 16, wherein the check valves are configured to receive the highest pressure hydraulic fluid from within the hydraulic manifold assembly and store the pressurized hydraulic fluid within the fluid circuit.

18. The method of claim 15, wherein the hydraulic manifold assembly is configured to control the movement of at least one hydraulic attachment.

19. The method of claim 15, wherein the hydraulic manifold includes four control modules, each control module being connected to at least one control valve.

20. The method of claim 15, wherein the control module is configured to allow the control valve to move to the open position when the control module is in the first state, and configured to not allow the control valve to move to the open position when the control module is in the second state.
